(19) United States
(12) Patent Application Publication
(10) Pub. No.: US 2021/0196019 A1
(43) Pub. Date: Jul. 1, 2021

(54) Electronic Display Luggage Apparatus

(71) Applicant: Gerald Charles, Cotati, CA (US)

(72) Inventor: Gerald Charles, Cotati, CA (US)

(21) Appl. No.: 16/728,055

(22) Filed: Dec. 27, 2019

(51) Int. Cl. A45C 15/00; A45C 5/03; A45C 13/18; A45C 5/14; A45C 13/26; G01G 19/52; G01S 19/03

(52) U.S. Cl. CPC A45C 15/00; A45C 5/03; A45C 13/18; A45C 2013/267; A45C 13/262; G01G 19/52; G01S 19/03; A45C 5/14

(57) ABSTRACT

An electronic display luggage apparatus for displaying information and preventing loss includes a luggage body having a front side separated from a back side, a bottom side separated from a top side, and a left side separated from a right side defining a luggage cavity. The luggage body has a zippered opening to open and alternatively close the luggage cavity. At least one handle is coupled to the luggage body. A display unit is coupled to the luggage body and includes a housing coupled within the luggage cavity and a display screen extending through the luggage body. The display unit includes a CPU, a battery, and a transceiver. The transceiver is in operational communication with a personal electronic device to program the information shown on the display screen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to luggage devices and more particularly pertains to a new luggage device for displaying information and preventing loss.

(2) Description of Related Art Including Information Disclosed Under 37 CFR 1.97 and 1.98

The prior art relates to luggage devices incorporating digital scales and displays. Most existing incorporated scaled are built into the luggage handle and require the entire suitcase to be lifted to get a reading, creating unnecessary work and strain on the user. Existing displays are typically limited to the current reading of the scale mechanism. Other existing electronic luggage tags are separate items that may be detached and lost from the luggage, and as they are free-moving more easily damaged.

### BRIEF SUMMARY OF THE INVENTION

An embodiment of the disclosure meets the needs presented above by generally comprising a luggage body having a front side separated from a back side, a bottom side separated from a top side, and a left side separated from a right side defining a luggage cavity. The luggage body has a zippered opening extending from the left side around the top side, the right side, and the bottom side to open and alternatively close the luggage cavity. At least one handle is coupled to the luggage body. A display unit is coupled to the luggage body and includes a housing coupled within the luggage cavity and a display screen extending through the luggage body. The display unit includes a CPU, a battery, and a transceiver coupled within the housing. The transceiver is configured to be in operational communication with a personal electronic device to program the information shown on the display screen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an electronic display luggage apparatus according to an embodiment of the disclosure.

FIG. 2 is a rear elevation view of an embodiment of the disclosure.

FIG. 3 is a side elevation view of an embodiment of the disclosure.

FIG. 4 is a front elevation view of an embodiment of the disclosure.

### DETAILED DESCRIPTION OF THE INVENTION

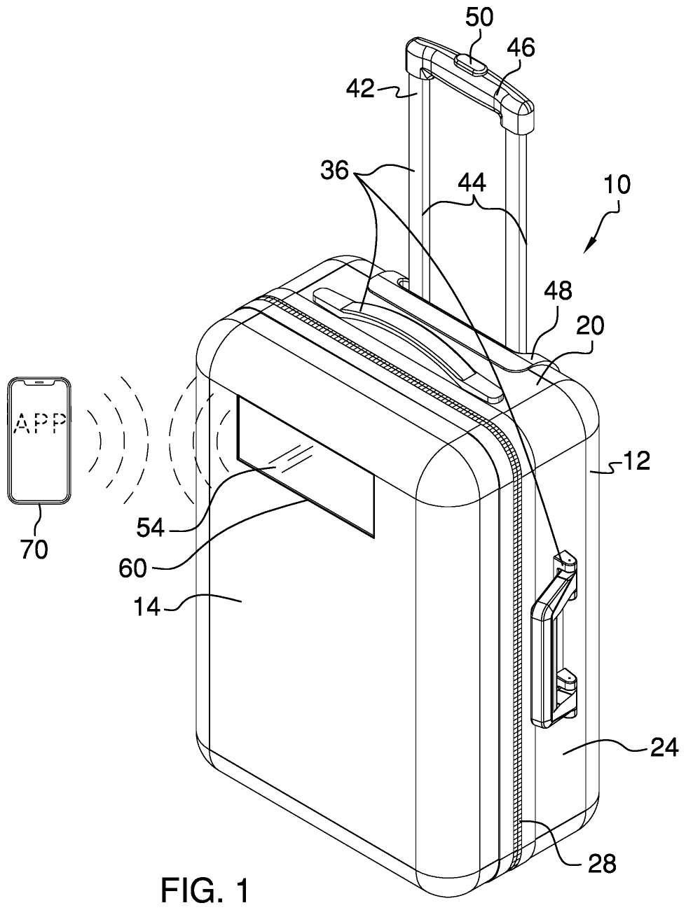

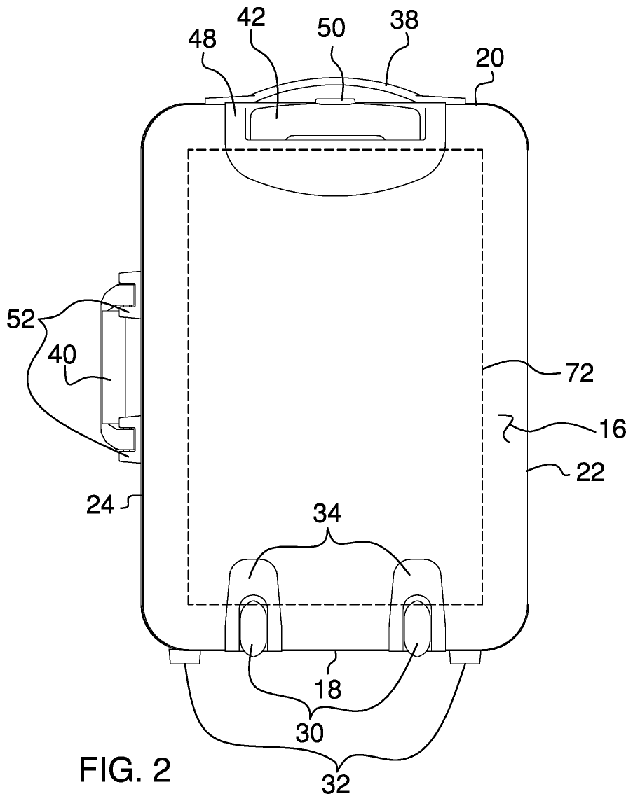

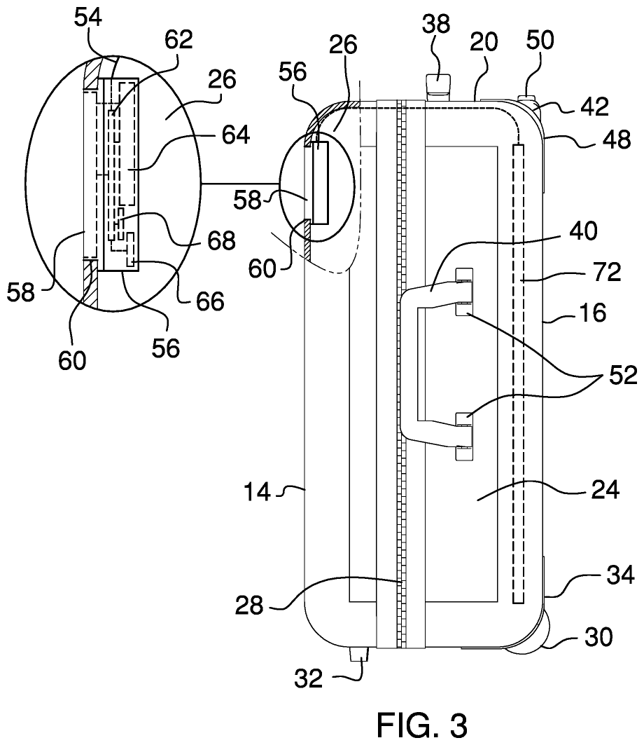

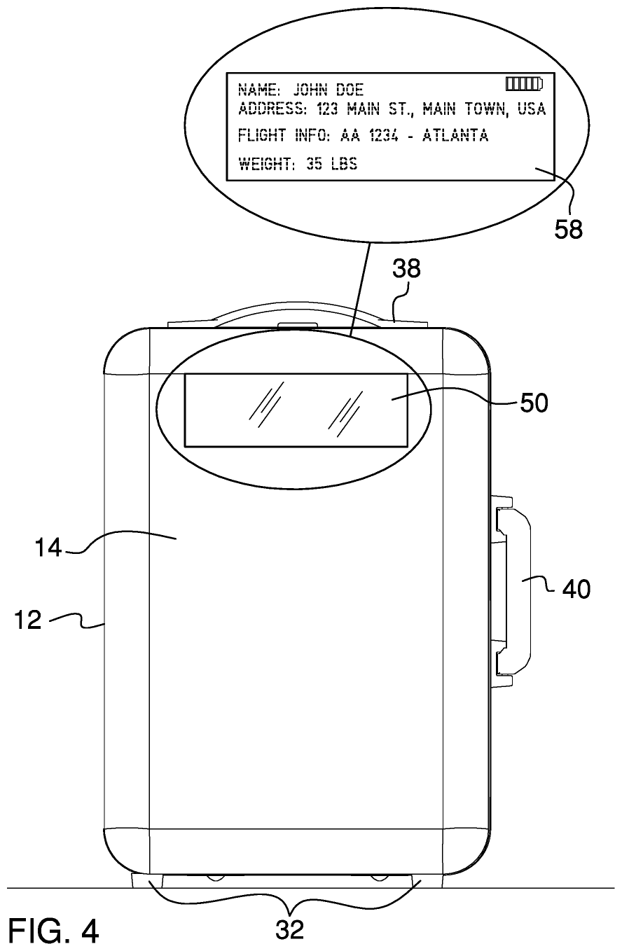

With reference now to the drawings, and in particular to FIGS. 1 through 4 thereof, a new luggage device embodying the principles and concepts of an embodiment of the disclosure and generally designated by the reference numeral 10 will be described.

As best illustrated in FIGS. 1 through 4, the electronic display luggage apparatus 10 generally comprises a luggage body 12 having a front side 14 separated from a back side 16, a bottom side 18 separated from a top side 20, and a left side 22 separated from a right side 24 defining a luggage cavity 26. The luggage body 12 has a zippered opening 28 extending from the left side 22 around the top side 20, the right side 24, and the bottom side 18 to open and alternatively close the luggage cavity 26. The luggage body 12 may have rounded edges and corners to prevent damage and injury, as well as for aesthetic appeal.

At least two wheels 30 are coupled to the bottom side 18 of the luggage body. A pair of support legs 32 may also be coupled to the bottom side 18 of the luggage body to allow the apparatus 10 to stand upright when there are only two wheels 30 in place. Each wheel 30 may be held within a reinforced wheel house 34 extending from the bottom side 18 to the back side 16. At least one handle 36 is coupled to the luggage body 12. The handles 36 may comprise a fixed top handle 38 coupled to the top side 20 of the luggage body, a side handle 40 coupled to the right side 24 of the luggage body, and a telescoping handle 42 coupled within the back side 16 of the luggage body. The telescoping handle 42 may include a pair of arms 44 slidingly coupled within the back side 16 and a handle portion 46 extending between the pair of arms 44. The handle portion 46 may be an ergonomic shape for improved user comfort. The handle portion 46 may rest within a handle house 48 extending from the back side 16 to the top side 20 when the telescoping handle 42 is in a retracted position to minimize the profile of the apparatus 10. A button 50 on the handle portion 46 may be in operational communication with a locking mechanism securing the pair of arms 44 in the retracted or extended positions until the button 50 is depressed. The side handle 40 may be pivotably coupled to a pair of handle brackets 52 extending from the right side 24. Each handle bracket 52 may secure both sides of the side handle 40 for maximum reinforcement when the apparatus 10 is lifted.

A display unit 54 is coupled to the luggage body 12. The display unit 54 includes a housing 56 coupled within the luggage cavity 26 and a display screen 58 extending through the front side 14 of the luggage body. The display screen 58 may be rectangular and may sit recessed within a rectangular display aperture 60 of the front side 14 of the luggage body in order to minimize damage. The display screen 58 may be an LCD, e-ink, or similar digital display technology. The display unit 54 includes a CPU 62, a battery 64, a GPS transmitter 66, and a transceiver 68 coupled within the housing 56. The transceiver 68 is configured to be in operational communication with a personal electronic device 70. The transceiver 68, the GPS transmitter 66, and the battery 64 are each in operational communication with the CPU 62. An application on the personal electronic device 70 may be used to program the information shown on the display screen 58 as well as to track the location of the apparatus 10 via the GPS transmitter 66. A scale 72 may be coupled within the back side 16 of the luggage body and is in operational communication with the display unit 54. The display screen 58 is configured to show a user's name, address, flight information, charge level of the battery 64, and the combined weight of the apparatus 10 and the contents held within the luggage cavity 26 as read by the scale 72.

In use, the apparatus 10 is placed with the back side 16 of the luggage body on the ground. Using the application on the personal electronic device 70 the user may then set the weight as the scale 72 is able to read the weight of the contents held within the luggage cavity 26 and the fixed weight of the apparatus 10 is stored within the CPU 62. The user may also enter the other desired information to be shown on the display screen 58. The apparatus 10 may then be manipulated using one of the handles 36 and treated as a traditional luggage item. Should the apparatus 10 be lost, the user is able to see the location provided by the GPS transmitter 66 to the personal electronic device 70 to aid in recovery.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic display luggage apparatus comprising:
a luggage body having a front side separated from a back side, a bottom side separated from a top side, and a left side separated from a right side defining a luggage cavity, the luggage body having a zippered opening extending from the left side around the top side, the right side, and the bottom side to open and alternatively close the luggage cavity;
at least one handle coupled to the luggage body; and
a display unit coupled to the luggage body, the display unit including a housing coupled within the luggage cavity and a display screen extending through the luggage body wherein the display unit is fixed to the luggage body, the display unit including a CPU, a battery, and a transceiver coupled within the housing, the transceiver being configured to be in operational communication with a personal electronic device to program the information shown visually on the display screen.

2. The electronic display luggage apparatus of claim 1 further comprising the display screen being rectangular and extending through the front side of the luggage body.

3. The electronic display luggage apparatus of claim 1 further comprising the display unit including a GPS transmitter coupled within the housing.

4. The electronic display luggage apparatus of claim 1 further comprising a scale coupled within the back side of the luggage body, the scale being in operational communication with the display unit.

5. The electronic display luggage apparatus of claim 1 further comprising at least two wheels coupled to the bottom side of the luggage body.

6. The electronic display luggage apparatus of claim 5 further comprising the handles comprising a fixed top handle coupled to the top side of the luggage body, a side handle coupled to the right side of the luggage body, and a telescoping handle coupled within the back side of the luggage body.

7. The electronic display luggage apparatus of claim 1 further comprising the display screen being configured to show a user's name, address, flight information, and charge level of the battery.

8. The electronic display luggage apparatus of claim 4 further comprising the display screen being configured to show the combined weight of the apparatus and the contents held within the luggage cavity as read by the scale.

9. An electronic display luggage apparatus comprising:
a luggage body having a front side separated from a back side, a bottom side separated from a top side, and a left side separated from a right side defining a luggage cavity, the luggage body having a zippered opening extending from the left side around the top side, the right side, and the bottom side to open and alternatively close the luggage cavity;
at least two wheels coupled to the bottom side of the luggage body;
at least one handle coupled to the luggage body, the handles comprising a fixed top handle coupled to the top side of the luggage body, a side handle coupled to the right side of the luggage body, and a telescoping handle coupled within the back side of the luggage body;
a display unit coupled to the luggage body, the display unit including a housing coupled within the luggage cavity and a display screen extending through the front side of the luggage body wherein the display unit is fixed to the luggage body, the display unit including a CPU, a battery, a GPS transmitter, and a transceiver coupled within the housing, the transceiver being configured to be in operational communication with a personal electronic device to program the information shown visually on the display screen; and
a scale coupled within the back side of the luggage body, the scale being in operational communication with the display unit, the display screen being configured to show a user's name, address, flight information, charge level of the battery, and the combined weight of the apparatus and the contents held within the luggage cavity as read by the scale.
